(19) United States
(12) Patent Application Publication
(10) Pub. No.: US 2015/0278869 A1
(43) Pub. Date: Oct. 1, 2015

(54) DISTRIBUTED SCHEDULING ALGORITHM FOR LARGE-SCALE ONLINE PROMOTIONAL CAMPAIGNS

(71) Applicant: LinkedIn Corporation, Mountain View, CA (US)

(72) Inventors: Xin Yi Huang, San Francisco, CA (US); Mitul Tiwari, Mountain View, CA (US); Pramod Chand Khincha, San Jose, CA (US); Yin Liu, San Jose, CA (US); Samir M. Shah, San Francisco, CA (US)

(21) Appl. No.: 14/581,281

(22) Filed: Dec. 23, 2014

Related U.S. Application Data
(60) Provisional application No. 61/972,046, filed on Mar. 28, 2014.

(51) Int. Cl. G06Q 30/02

(52) U.S. Cl. CPC G06Q 30/0264; G06Q 30/0269

(57) ABSTRACT

Disclosed in some examples, are systems, methods, and machine readable mediums which implement a scalable algorithm for scheduling promotional campaigns of an online service that satisfy a set of desired constraints while at the same time maximizing a total utility. This algorithm is capable of scheduling hundreds of campaigns for millions of members. In some examples, each promotional campaign may have a utility (which may be described by a utility function) for a particular member and a goal of the scheduling algorithm may be to maximize the total utility for all members eligible for the promotional campaign while satisfying various constraints.

### CLAIM OF PRIORITY

This patent application claims the benefit of priority to U.S. Provisional Patent Application Ser. No. 61/972,046, entitled “Distributed Scheduling Algorithm for Large-Scale Online Marketing,” filed on Mar. 28, 2014 to Huang, et al, which is hereby incorporated by reference herein in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright LinkedIn, 2104 All Rights Reserved.

### BACKGROUND

A social networking service is a computer or web-based service that enables users to establish links or connections with persons for the purpose of sharing information with one another. Some social network services aim to enable friends and family to communicate and share with one another, while others are specifically directed to business users with a goal of facilitating the establishment of professional networks and the sharing of business information. For purposes of the present disclosure, the terms “social network” and “social networking service” are used in a broad sense and are meant to encompass services aimed at connecting friends and family (often referred to simply as “social networks”), as well as services that are specifically directed to enabling business people to connect and share business information (also commonly referred to as “social networks” but sometimes referred to as “business networks” or “professional networks”).

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is an example of an implementation of a scheduled online promotional campaign according to some examples of the present disclosure.

FIG. 2 is a schematic of a social networking system according to some examples of the present disclosure.

FIG. 3 is a flowchart of a technique to determine a campaign with maximum utility for a member from a subset of campaigns according to some examples of the present disclosure.

FIG. 4 is a schematic of a machine according to some examples of the present disclosure.

### DETAILED DESCRIPTION

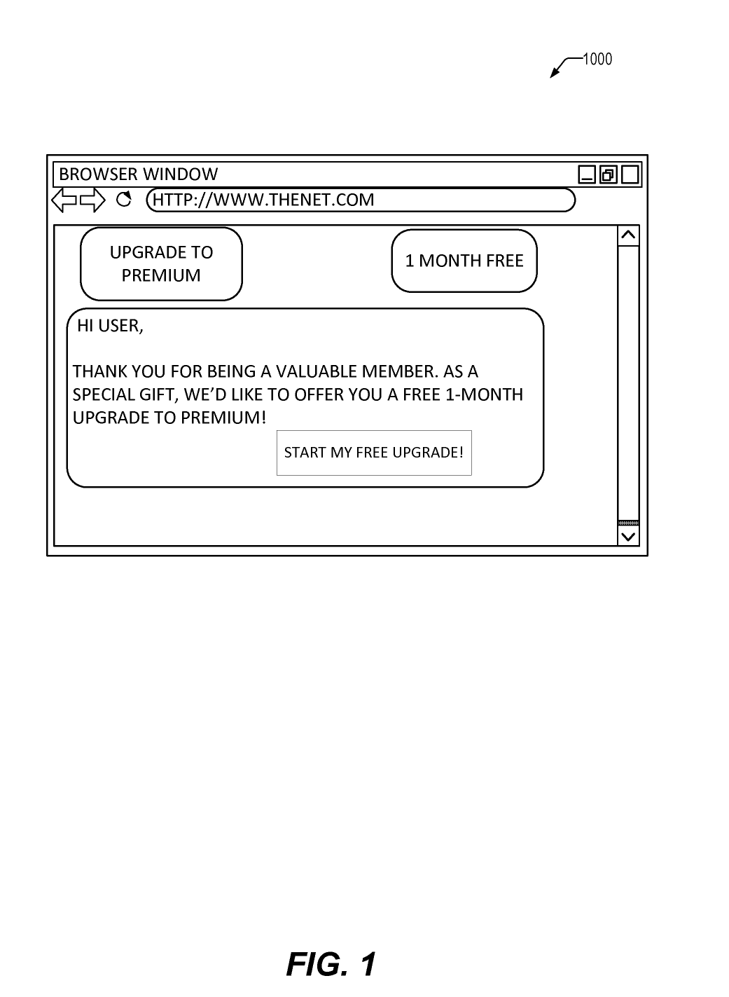

Promotional campaigns are an important component to online services such as a social networking service. Promotional campaigns allow the online service to attract new members, sell premium memberships, introduce members to new features, and the like. Promotional material may be shown at a position on a web page, as an interstitial between web pages, through personal messaging, or the like. For example, FIG. 1 shows an online promotional interface 1000 for a campaign which seeks to upgrade an account of a user of an online service to a premium account. The campaign 1000 may be displayed in a browser. The campaign 1000 may include an option to accept the campaign 1000, such as a link. In an example, the link may allow a member to upgrade to a premium account as shown in the browser. The campaign 1000 may also include banners, text, images, indications, links, or the like, such as those shown in FIG. 1. The campaign 1000 may be displayed in the browser on a computer, tablet, phone, laptop, etc.

Because of the ease of delivering online promotional material (as opposed to print and other media), users of online services may be bombarded with promotional campaigns. At any given time, there may be hundreds of campaigns targeted to different segments of members. A segment of members may include a group of members sharing a common attribute, such as geographic location, profession, status (as in the case of premium or non-premium members), school, age, gender, or the like. Unless the promotional campaigns are smartly managed, members may be repeatedly shown the same campaign or may not be targeted at all. Presenting an ineffective promotional campaign repeatedly has the potential to annoy a user, and wastes an opportunity to present an effective promotional campaign to the user. As a result, scheduling online promotional campaigns for members of an online service (e.g., a social networking service) requires smart management. Such smart management entails delivering the right promotions to the right members at the right times without annoying the member. Such smart management becomes increasingly difficult as the number of promotional campaigns increases.

Disclosed in some examples, are systems, methods, and machine readable mediums which implement a scalable algorithm for scheduling promotional campaigns of an online service that satisfy a set of desired constraints while at the same time maximizing a total utility. This algorithm is capable of scheduling hundreds of campaigns for millions of members. In some examples, each promotional campaign may have a utility (which may be described by a utility function) for a particular member and a goal of the scheduling algorithm may be to maximize the total utility for all members eligible for the promotional campaign while satisfying various constraints. Example constraints may include: ensuring each member is not exposed to the same campaign too often (or even more than once), ensuring that the campaign is to be exposed to a sufficient number of members when it becomes eligible, and ensuring that a campaign is to be repeated a specified number of times in a given time period. Using the disclosed methods, systems, and machine readable mediums allows for smart scheduling of a large number of promotional campaigns. The resulting schedule is desirable in that the promotional campaigns are scheduled in a way that maximizes the utility for the group of members that are being scheduled.

In an example the scheduling algorithm may generate a schedule of campaigns that are to be delivered to one or more members. The scheduling algorithm operates within a particular period of time, and divides that time into a series of timeslots. The algorithm may choose from a pool or set of available campaigns in order to schedule the promotional campaigns in order to maximize a specific utility function. In some examples, the scheduling algorithm may schedule one campaign per member for each timeslot. In other examples, the scheduling algorithm may schedule multiple campaigns per member for each timeslot.

The scheduling algorithm may be a distributed algorithm, which may be utilized to generate a schedule including hundreds of campaigns for millions of members. By utilizing the algorithm in a distributed form, the online service may utilize distributed computing resources to quickly compute the schedule. The scheduling algorithm may be linear and easily parallelizable, such as being usable in the MapReduce paradigm. In another example, the scheduling algorithm may be scalable to hundreds of millions of members or more, and may be able to operate on a dynamically changing pool of campaigns. The algorithm may also operate on a set of campaigns having a high turnover rate.

As previously noted, the scheduling algorithm may use a specified utility function, for example, U(c, M), to calculate a utility value U of showing campaign c to member M. U(c, M) may be complete, transitive, continuous, and deterministic. In other words, U(c, M) may provide a total order across messages c to member M, such as by ordering messages c in a particular utility order for member M from highest utility to lowest utility. A greedy-type quality of the present scheduling algorithm may be driven by a goal of maximizing cumulative values generated from the utility function for a set of campaigns and a group of members.

In some examples, the utility function may be a strict priority scheme of campaigns. In other examples, the utility score may be calculated using attributes of the member. In another example, other factors derived from business and propensity models may be used to calculate the utility function. The utility returned by the utility function may represent a calculated value of a particular promotional campaign to a particular member. The value of a particular promotional campaign to a particular member may be an estimated interest of the member in the subject of the promotional campaign.

As previously noted, the scheduling algorithm in some examples factors in one or more constraints. Example constraints may include exposure constraints. For example, an under-exposure constraint specifies a constraint on the minimum amount of promotional exposure, e.g., a minimum number of members that receive a particular campaign in a particular time period (e.g., one or more timeslots). For example, an under-exposure constraint of 15% for a specific campaign specifies that at least 15% of eligible members will be scheduled for the particular campaign in a particular time period (e.g., a particular timeslot). This constraint minimizes, if not eliminates altogether, starvation of any campaigns. As another example, an over-exposure constraint may be utilized. An over-exposure constraint may be a constraint on the maximum amount of promotional exposure, e.g., a maximum number of members that receive a particular campaign in a particular time period (e.g., one or more timeslots). The over-exposure constraint prevents a particular promotional campaign from being shown to too many eligible members in a particular time period, which may over-saturate the promotional campaign and in some cases starve other campaigns.

The scheduling algorithm in some examples factors in duplication constraints. In some examples, the campaign may be promoted to the same member a limited number of times (e.g., once) within a predetermined number of time slots. This constraint may cause the scheduling algorithm to stagger the campaigns throughout the schedule, prevents a member from being annoyed by repeated exposures, and distributes a particular campaign more evenly across the schedule such that the promoted service does not peek in popularity for one time slot and lose traffic for the remainder of the schedule.

The scheduling algorithm in some examples factors in a repeat frequency constraint. In some examples, the repeat frequency specifies a minimum frequency with which a campaign should be promoted to each applicable member of the online service over a predetermined number of timeslots. This ensures that the campaign is repeated a predetermined number of times.

The scheduling algorithm in some examples includes eligibility date constraints. These constraints may specify that a campaign is to be scheduled before or after certain dates, during specific time periods, such as a particular time of day, a particular hour, a total duration of time, or the like.

The constraints may be member specific, campaign specific, global, or some constraints may be member specific, some may be campaign specific, and some may be global. Member specific constraints may include specific constraints on the quantity of promotions shown, content of promotions, and format of promotions shown to users. These member specific constraints may be based upon preference settings given by a member or member-specific attributes that determine eligibility for a type of campaign. For example, a premium member may receive fewer promotions than a standard member. In other examples, the member specific constraints may be calculated by the online service. For example, a propensity model may predict the likelihood of a member to install a mobile application. The output of the propensity model may be used to prioritize a campaign to suggest installation of the mobile application to members identified as likely to install the mobile application.

In an example, the scheduling algorithm may use some or all of the given constraints, by using parameters for each campaign in association with some granularity value, τ, which determines the number of time slots for the schedule. For example, τ may be a time period, such as days for a campaign that cycles daily, hours, minutes, weeks, months, years, a website visit, or the like.

The constraints discussed above may be quantified in the scheduling algorithm. For example, k may represent a no-repeat factor, such as for a campaign that can be shown once to the same member within k time slots. Another constraint may be represented by 1, a repeat frequency value that specifies how many times a campaign should be shown to any applicable member over a given time frame. A value Tᵢ may represent an eligible start date for a campaign to begin. In other words, a campaign may be eligible to run at or after time or date Tᵢ. In another example, the eligible start date may be a periodic time or date, and a campaign may be shown again to a member after time or date Tᵢ₊₁. In an example, eₘᵢₙ may represent a minimal exposure of the campaign within a time slot, such as a minimum number of times the campaign may run in the time slot. In another example, eₘₐₓ may represent a maximal exposure of the campaign within a time slot, such as a maximum number of times the campaign may run in the time slot. A value e(c) may be used by the scheduling algorithm to determine the current exposure amount for a campaign c at a particular time. When the current exposure amount is less than the minimum exposure amount for campaign c, the campaign may be run. If the current exposure amount is greater than the maximum exposure amount, the campaign may not be run again until a later time. In an example, when the current exposure amount for a campaign is between the minimum exposure amount and the maximum exposure amount, the campaign may be run or may not be run. Whether the campaign runs may depend on whether another campaign is available that has the same or a similar utility but with a lower current exposure amount. A minimum exposure amount and maximum exposure amount may have different values for different campaigns. The maximum exposure amount may be greater than or equal to the minimum exposure amount.

In an example, a scheduling algorithm may include constraints and utilize parameters and functions such as:
U(c, M) utility of showing a campaign c to a member M
k(c) no-repeat factor for campaign c
l(c) repeat frequency for campaign c
T(c) eligible start dates for campaign c
e(c) exposure amount for campaign c
eₘᵢₙ(c) minimum exposure amount for campaign c
eₘₐₓ(c) maximum exposure amount for campaign c
getCampaigns(C, M, i) Returns a set of campaigns C applicable for member M during a specific time slot i based on k(c), l(c), T(c), or member-campaign constraints, if any
getUnderexposed(C, i) Returns a set of campaigns C wherein e(c)<eₘᵢₙ(c) for each campaign in the set of campaigns for time slot i
getOverexposed(C, i) Returns a set of campaigns C wherein e(c)≧eₘₐₓ(c) for each campaign in the set of campaigns for time slot i

Pseudocode for one example scheduling algorithm may be:

```
for all Member M do
  Cₐₗₗ ← all Campaigns
  C ← getCampaigns(Cₐₗₗ, M, 0)
  for all i ∈ [0, τ] do
    C′ ← getUnderexposed(C, i)
    if (C′ is empty) C′← C - getOverexposed(C′, i)
    if (C′ is empty) continue
    m ← argmaxₓ_{^{∈}}_{C′} {U(x, M)}
    Schedule_{Mi} ← m
    C′← getCampaigns(Cₐₗₗ, M, i + 1)
  end for
end for
```

In the above scheduling algorithm, for each member of the online service, the algorithm may identify a set of all campaigns (Cₐₗₗ). For each particular timeslot that needs to be scheduled, the scheduling algorithm identifies a set (C) of campaigns applicable for a particular member and for the currently scheduled timeslot from the set of all campaigns (Cₐₗₗ). This determination is made by returning all campaigns applicable for the member during the specified time slot based upon k(c), l(c), and T(c), where c is the campaign, and any member-campaign constraints.

The scheduling algorithm may then select a subset of campaigns C′ from C that have run fewer times than a minimum threshold, such as by using a getUnderexposed function where e(c)<eₘᵢₙ(c). If there are no campaigns or fewer campaigns than a specified minimum number of campaigns in C′, the scheduling algorithm may then fill C′ with campaigns from C but excluding campaigns that have run more times than a maximum threshold. For example, the newly selected campaigns may include campaigns in C excluding campaigns returned by a getOverexposed function for campaigns (where e(c)≧eₘₐₓ(c)). The scheduling algorithm may then determine a campaign with maximum utility for the member from the set of campaigns C′. For example, the campaign with maximum utility for the member from the campaigns in C′ may be determined using a function, such as argmax_{xεC′} (which returns the campaign from C′ which has the highest score from the utility function). In an example, the scheduling algorithm may also include scheduling the campaign to run for the member, such as using a function (e.g., Schedule_{Mi}).

In an example, if eₘᵢₙ=0, eₘₐₓ=∞, and k=1 for all campaigns in the set of campaigns, then the algorithm maximizes member campaign utility and satisfies repetition and eligibility constraints. For example, if eₘᵢₙ=0, eₘₐₓ=∞, and k=1, then the algorithm may not prevent starvation nor enforce staggering and duplication constraints. Thus the scheduling algorithm may pick up a campaign with maximum utility (that may satisfy repetition and eligibility constraints) for each time slot, and also may maximize total utility.

In some examples, the algorithm may be run on a single member, in other examples, the algorithm may run for all members of the online service. In still other examples, the member base may be partitioned into p groups. The groups may have the same or substantially the same number of members or may have different numbers of members. The groups may be partitioned according to member attributes. The scheduling algorithm may be run sequentially within the groups. For example, the scheduling algorithm may update a local exposure count for a campaign in a group after a member iteration. The minimum exposure amount or the maximum exposure amount may be divided among the groups, such as by creating a local minimum exposure amount or a local maximum exposure amount for each campaign in each group. A campaign may have many local minimum exposure amounts or maximum exposure amounts and the local amounts may add up to a total minimum exposure amount or a total maximum exposure amount. Any of the above described exposure amounts may include a numerical value, a proportion, a ratio, a percentage, or the like. The local exposure amounts may include portion of the total exposure amounts, such as a proportion, a ratio, a percentage, or the like. The eₘᵢₙ and eₘₐₓ of each campaign may be expressed as a percentage or a concrete number and may be applied to each partition.

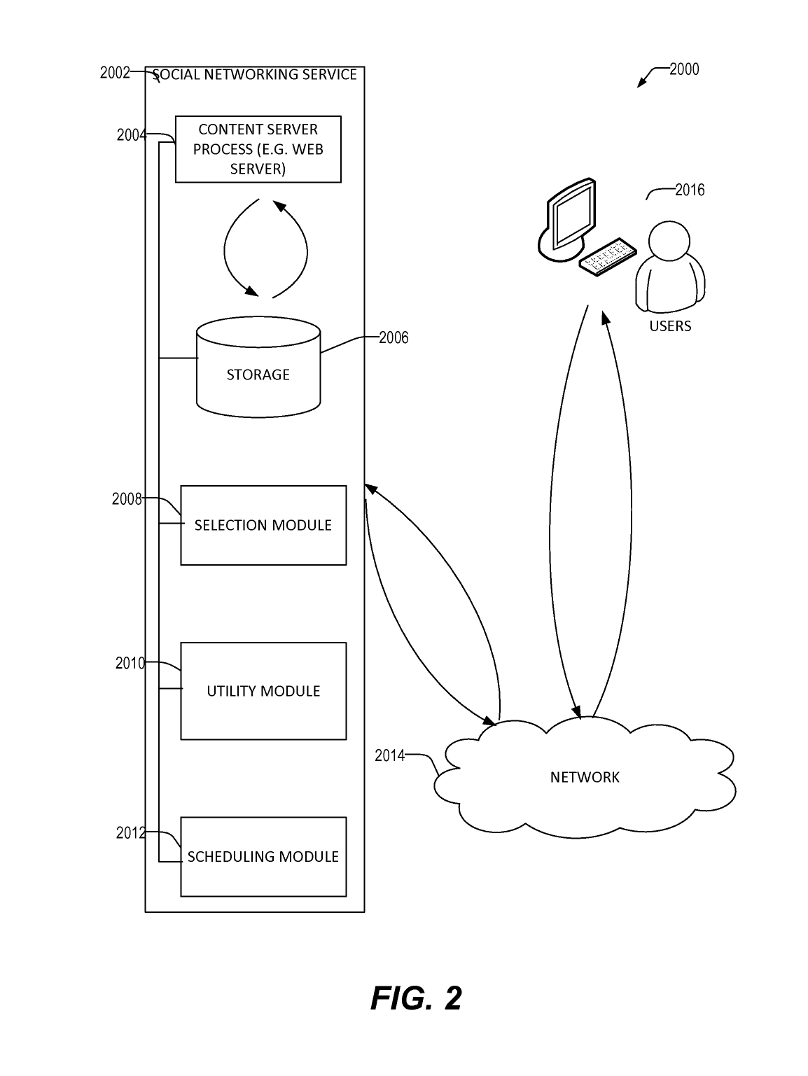

FIG. 2 is a schematic of an example network service in the form of a social networking system 2000 according to some examples of the present disclosure. Social networking service 2002 may contain a content server process 2004. Content server process 2004 may communicate with storage 2006 and may communicate with one or more users 2016 through a network 2014. Content server process 2004 may be responsible for the retrieval, presentation, and maintenance of member profiles stored in storage 2006. Content server process 2004 in one example may include or be a web server that fetches or creates internet web pages. Web pages may be or include Hyper Text Markup Language (HTML), eXtensible Markup Language (XML), JavaScript, or the like. The web pages may include portions of, or all of, a member profile at the request of users 2016. The web pages may include search functionality—for example, the ability to search for particular members, search for members with particular skills, browse skill hierarchies, and the like.

Users 2016 may include one or more members, prospective members, or other users of the social networking service 2002. Users 2016 access social networking service 2002 using a computer system through a network 2014. The network may be any means of enabling the social networking service 2002 to communicate data with users 2016. Example networks 2014 may be or include portions of one or more of: the Internet, a Local Area Network (LAN), a Wide Area Network (WAN), wireless network (such as a wireless network based upon an IEEE 802.11 family of standards), a Metropolitan Area Network (MAN), a cellular network, or the like.

Social networking service 2002 may include a selection module 2008 to select a subset of campaigns which may be evaluated to determine their utility. The selection module 2008 may implement the scheduling algorithm as described above to schedule campaigns to achieve a maximum utility subject to various constraints. In some examples, this may be done with the help of the utility module 2010. The utility module 2010, given a member and a campaign, may return a utility value for the member based upon one or more of the methods described above.

For example, in the pseudocode scheduling algorithm shown above, the selection module 2008 may first get a set Cₐₗₗ of all campaigns that are valid for the member M. Then, for each particular timeslot to schedule, the selection module 2008 may select a subset C of campaigns from Cₐₗₗ that is applicable for member M during the particular timeslot. This selection may be done subject to constraints, such as a no-repeat factor, repeat frequency, and eligibility dates. The selection module may then schedule the promotion with the highest utility (based upon output from the utility module) from C that is also below a minimum exposure value (e.g., a promotion that has been exposed<eₘᵢₙ.) If no such promotion exists, the scheduling module may then schedule the highest utility promotion from C that is not over-exposed (e.g., a promotion that has been exposed<eₘₐₓ.)

In an example, social networking service 2002 may include a scheduling module 2012. The scheduling module 2012 may schedule a campaign to run for a member, such as the campaign identified for the member by the utility module 2010. For example, the scheduling module 2012 may record the promotions determined by the selection module 2008 in storage 2006. Content server process 2004 may then access storage 2006 to determine which promotions to create and deliver to users 2016 when the users 2016 access the social networking service 2002.

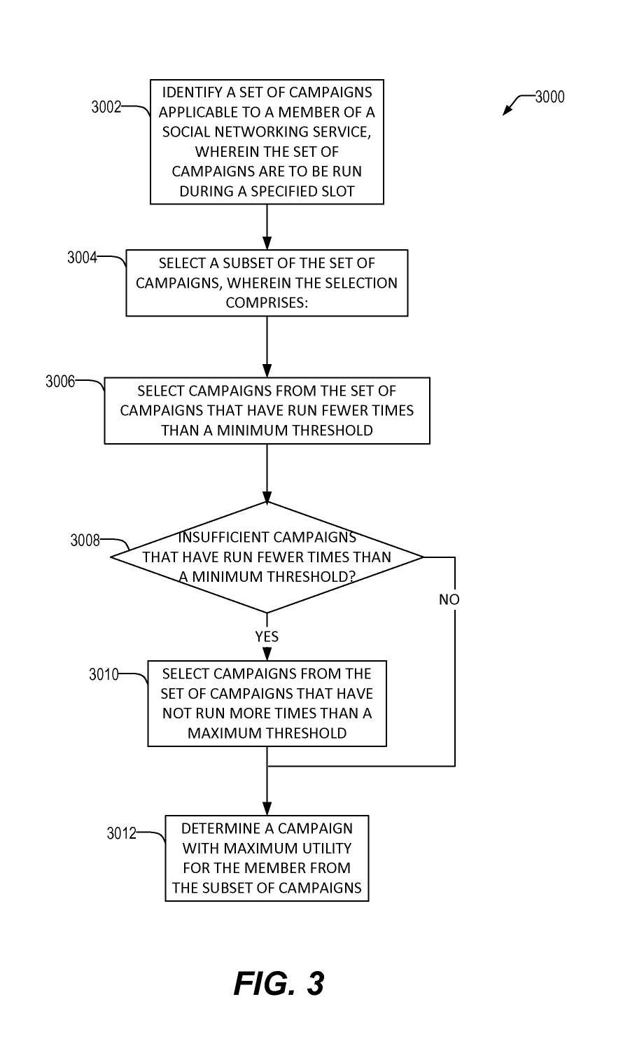

FIG. 3 is a flowchart of a technique to determine a campaign with maximum utility for a member from a subset of campaigns according to some examples of the present disclosure. At operation 3002, a technique includes identifying a set of campaigns applicable to a member of a social networking service, wherein the set of campaigns are to be run during a specified slot. At operation 3004, the technique includes selecting a subset of the set of campaigns, wherein the selection comprises selecting campaigns from the set of campaigns that have run fewer times than a minimum threshold, at operation 3006. At operation 3008, the technique includes, when there are insufficient campaigns that have run fewer times than a minimum threshold, selecting campaigns from the set of campaigns that have not run more times than a maximum threshold, at operation 3010. When there are sufficient campaigns that have run fewer times than a minimum threshold, the technique may proceed directly to operation 3012. At operation 3012, the technique includes determining a campaign with maximum utility for the member from the subset of campaigns using a utility function.

In an example, the campaign with maximum utility for the member may run for the member. Determining the campaign with maximum utility using the techniques described herein allows a system to conserve processing power and/or time. Reducing processing power or time allows a system, such as a Hadoop server to run more quickly. For example, determining the campaign with maximum utility may allow a system to not need to run unnecessary campaigns, reject previously scheduled campaigns, or the like.

In an example, a distributed variant of the scheduling algorithm may be parallelizable. For example, the member base may be partitioned evenly into p groups and the algorithm may be run sequentially within the groups. The local exposure count for each group may be updated after each member iteration. In some examples, the eₘᵢₙ and eₘₐₓ of each message type may be expressed as a percentage as opposed to a concrete number so it may be applied to each partition.

In an example distributed variant, the scheduling algorithm generated a schedule with exposure counts for each campaign close to the original un-distributed algorithm with only slight deviations due to percentage rounding. In some examples, given a uniform distribution of members for the partitions based upon campaign eligibility, the resulting exposure statistics may be approximately the same as if no partitioning was done. If however a non-uniform distribution is chosen, by scaling all campaign eₘᵢₙ and eₘₐₓ values for each partition uniquely by the ratio of its eligible member count to the total eligible member count across all partitions, a similar result to the non-partitioned algorithm may be achieved. In these examples, parallelism may be achieved without the use of any shared global state.

In one example implementation, several different campaigns were scheduled with user-specific exposure ranges, repetition rules, and utility values as shown in Table 1 (below). In some examples, a strict prioritization scheme for the utility function may be used (e.g., a hard coded utility based upon the campaign). The scheduling algorithm was run with 500 members, 8 campaigns over 65 total weekdays. Using the data in the table below, the scheduling algorithm may produce a result that has a total utility of 94% of the possible utility, the possible utility being the utility that results from choosing campaigns when constraints are ignored, based solely on the utility value.

TABLE 1
Constraint table example.

| Campaign | Utility | eₘᵢₙ | eₘₐₓ | k | l | Timeslots Scheduled |
|---|---|---|---|---|---|---|
| 1 | 10 | 7% | 15% | 16 | 4 | 0, 16, 32, 48 |
| 2 | 10 | 7% | 15% | 16 | 4 | 0, 16, 32, 48 |
| 3 | 10 | 7% | 15% | 16 | 4 | 0, 16, 32, 48 |
| 4 | 15 | 7% | 15% | 4 | 13 | 0, 5, 10, 15, 20, 25, 30, |
| | | | | | | 35, 40, 45, 50, 55, 60 |
| 5 | 75 | 10% | 25% | 4 | 13 | 0, 5, 10, 15, 20, 25, 30, |
| | | | | | | 35, 40, 45, 50, 55, 60 |
| 6 | 30 | 8% | 20% | 4 | 13 | 0, 5, 10, 15, 20, 25, 30, |
| | | | | | | 35, 40, 45, 50, 55, 60 |
| 7 | 75 | 10% | 25% | 4 | 13 | 0, 5, 10, 15, 20, 25, 30, |
| | | | | | | 35, 40, 45, 50, 55, 60 |
| 8 | 100 | 18% | 35% | 16 | 1 | 0 |

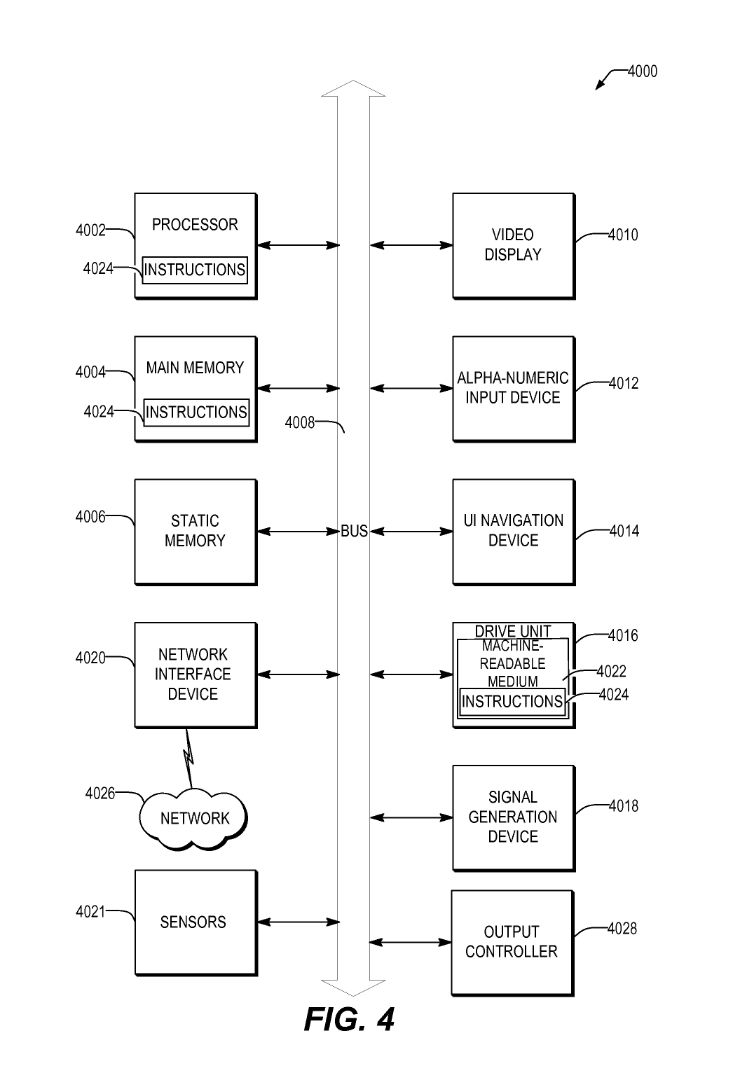

FIG. 4 illustrates a block diagram of an example machine 4000 upon which any one or more of the techniques (e.g., methodologies) discussed herein may be performed. In alternative embodiments, the machine 4000 may operate as a standalone device or may be connected (e.g., networked) to other machines. In a networked deployment, the machine 4000 may operate in the capacity of a server machine, a client machine, or both in server-client network environments. In an example, the machine 4000 may act as a peer machine in peer-to-peer (P2P) (or other distributed) network environment. The machine 4000 may be a personal computer (PC), a tablet PC, a set-top box (STB), a personal digital assistant (PDA), a mobile telephone, a smart phone, a web appliance, a network router, switch or bridge, a machine implementing any of the components of FIG. 2, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 4000 may include a hardware processor 4002 (e.g., a central processing unit (CPU), a graphics processing unit (GPU), a hardware processor core, or any combination thereof), a main memory 4004 and a static memory 4006, some or all of which may communicate with each other via an interlink (e.g., bus) 4008. The machine 4000 may further include a display unit 4010, an alphanumeric input device 4012 (e.g., a keyboard), and a user interface (UI) navigation device 4014 (e.g., a mouse). In an example, the display unit 4010, input device 4012 and UI navigation device 4014 may be a touch screen display. The machine 4000 may additionally include a storage device (e.g., drive unit) 4016, a signal generation device 4018 (e.g., a speaker), a network interface device 4020, and one or more sensors 4021, such as a global positioning system (GPS) sensor, compass, accelerometer, or other sensor. The machine 4000 may include an output controller 4028, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 4016 may include a machine readable medium 4022 on which is stored one or more sets of data structures or instructions 4024 (e.g., software) embodying or utilized by any one or more of the techniques, methods, or functions described herein. The instructions 4024 may also reside, completely or at least partially, within the main memory 4004, within static memory 4006, or within the hardware processor 4002 during execution thereof by the machine 4000. In an example, one or any combination of the hardware processor 4002, the main memory 4004, the static memory 4006, or the storage device 4016 may constitute machine readable media.

While the machine readable medium 4022 is illustrated as a single medium, the term “machine readable medium” may include a single medium or multiple media (e.g., a centralized or distributed database, and/or associated caches and servers) configured to store the one or more instructions 4024.

The term “machine readable medium” may include any medium that is capable of storing, encoding, or carrying instructions for execution by the machine 4000 and that cause the machine 4000 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 4024 may further be transmitted or received over a communications network 4026 using a transmission medium via the network interface device 4020. The Machine 4000 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 4020 may include one or more physical jacks (e.g., Ethernet, coaxial, or phone jacks) or one or more antennas to connect to the communications network 4026. In an example, the network interface device 4020 may include a plurality of antennas to wirelessly communicate using at least one of single-input multiple-output (SIMO), multiple-input multiple-output (MIMO), or multiple-input single-output (MISO) techniques. In some examples, the network interface device 4020 may wirelessly communicate using Multiple User MIMO techniques.

### VARIOUS NOTES & EXAMPLES

Additional examples of the presently described method, system, and device embodiments are suggested according to the structures and techniques described herein. Other non-limiting examples can be configured to operate separately, or can be combined in any permutation or combination with any one or more of the other examples provided above or throughout the present disclosure.

Example 1 includes subject matter (such as a method, means for performing acts, machine readable medium including instructions that when performed by a machine cause the machine to performs acts, or an apparatus to perform) comprising: using one or more computer processors: for each particular one of a plurality timeslots, identifying a set of campaigns applicable to a particular member of a social networking service during the particular timeslot based upon at least one constraint; and selecting a campaign from the set of campaigns to run during the particular timeslot for the particular member based upon determining which of the campaigns in the set returns a maximum utility for the member from the set of campaigns.

In Example 2, the subject matter of Example 1 may include, further comprising, scheduling the campaign to run for the member.

In Example 3, the subject matter of any one of Examples 1 to 2 may include, wherein the constraint is a duplication constraint and wherein identifying the set of campaigns includes excluding campaigns that have run previously during a particular time period.

In Example 4, the subject matter of any one of Examples 1 to 3 may include, wherein the constraint is a repetition constraint and wherein identifying the set of campaigns includes including campaigns that have run fewer times for the member than a specified member threshold.

In Example 5, the subject matter of any one of Examples 1 to 4 may include, wherein the constraint is an eligibility constraint and wherein identifying the set of campaigns includes identifying campaigns that have an eligible start slot after the specified slot.

In Example 6, the subject matter of any one of Examples 1 to 5 may include, further comprising, iterating the method for a specified number of members.

In Example 7, the subject matter of any one of Examples 1 to 6 may include, wherein the specified number of members is a number of members in a predetermined group.

Example 8 includes subject matter (such as a device, apparatus, or machine) comprising: a selection module configured to: for each particular one of a plurality timeslots, identify a set of campaigns applicable to a particular member of a social networking service during the particular timeslot based upon at least one constraint; and a utility module configured to determine a utility for the member of each particular campaign in the set of campaigns; wherein the selection module is configured to select a campaign from the set of campaigns to run during the particular timeslot for the particular member based upon the campaign determined by the utility module to have a maximum utility for the member from the set of campaigns.

In Example 9, the subject matter of Example 8 may include, further comprising, a scheduling module to schedule the campaign to run for the member.

In Example 10, the subject matter of any one of Examples 8 to 9 may include, wherein the constraint is a duplication constraint and wherein to identify the set of campaigns, the selection module is to exclude campaigns that have run previously during a particular time period.

In Example 11, the subject matter of any one of Examples 8 to 10 may include, wherein the constraint is a repetition constraint and wherein to identify the set of campaigns, the selection module is to include campaigns that have run fewer times for the member than a specified member threshold.

In Example 12, the subject matter of any one of Examples 8 to 11 may include, wherein the constraint is an eligibility constraint and wherein to identify the set of campaigns, the selection module is to include campaigns that have an eligible start slot after the specified slot.

In Example 13, the subject matter of any one of Examples 8 to 12 may include, wherein the selection module is configured to perform the identification and selection and the utility module is configured to perform the determining for a specified number of members.

In Example 14, the subject matter of any one of Examples 8 to 13 may include, wherein the specified number of members is a number of members in a predetermined group.

Each of these non-limiting examples can stand on its own, or can be combined in various permutations or combinations with one or more of the other examples.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

What is claimed is:

1. A method comprising:
using one or more computer processors:
for each particular one of a plurality timeslots, identifying a set of campaigns applicable to a particular member of a social networking service during the particular timeslot based upon at least one constraint; and
selecting a campaign from the set of campaigns to run during the particular timeslot for the particular member based upon determining which of the campaigns in the set returns a maximum utility for the member from the set of campaigns.

2. The method of claim 1, further comprising, scheduling the campaign to run for the member.

3. The method of claim 1, wherein the constraint is a duplication constraint and wherein identifying the set of campaigns includes excluding campaigns that have run previously during a particular time period.

4. The method of claim 1, wherein the constraint is a repetition constraint and wherein identifying the set of campaigns includes including campaigns that have run fewer times for the member than a specified member threshold.

5. The method of claim 1, wherein the constraint is an eligibility constraint and wherein identifying the set of campaigns includes identifying campaigns that have an eligible start slot after the specified slot.

6. The method of claim 1, further comprising, iterating the method for a specified number of members.

7. The method of claim 6, wherein the specified number of members is a number of members in a predetermined group.

8. A system comprising:
a processor; and
a memory including instructions, which when executed by the processor, cause the processor to:
for each particular one of a plurality timeslots, identify a set of campaigns applicable to a particular member of a social networking service during the particular timeslot based upon at least one constraint; and
determine a utility for the member of each particular campaign in the set of campaigns;
select a campaign from the set of campaigns to run during the particular timeslot for the particular member based upon the campaign determined by the utility module to have a maximum utility for the member from the set of campaigns.

9. The system of claim 8, wherein the instructions include further instructions, which when executed by the processor cause the processor to schedule the campaign to run for the member.

10. The system of claim 8, wherein the constraint is a duplication constraint and wherein to identify the set of campaigns, the processor is to exclude campaigns that have run previously during a particular time period.

11. The system of claim 8, wherein the constraint is a repetition constraint and wherein to identify the set of campaigns, the processor is to include campaigns that have run fewer times for the member than a specified member threshold.

12. The system of claim 8, wherein the constraint is an eligibility constraint and wherein to identify the set of campaigns, the processor is to include campaigns that have an eligible start slot after the specified slot.

13. The system of claim 8, wherein the processor is configured to perform the identification, selection, and the determining operations for a specified number of members.

14. The system of claim 13, wherein the specified number of members is a number of members in a predetermined group.

15. A non-transitory machine-readable medium comprising instructions that, when executed by one or more processors of a machine, cause the machine to perform operations of:
for each particular one of a plurality timeslots, identifying a set of campaigns applicable to a particular member of a social networking service during the particular timeslot based upon at least one constraint; and
selecting a campaign from the set of campaigns to run during the particular timeslot for the particular member based upon determining which of the campaigns in the set returns a maximum utility for the member from the set of campaigns.

16. The machine-readable medium of claim 15, further comprising, operations to schedule the campaign to run for the member.

17. The machine-readable medium of claim 15, wherein the constraint is a duplication constraint and wherein the operations of identifying the set of campaigns includes the operations of excluding campaigns that have run previously during a particular time period.

18. The machine-readable medium of claim 15, wherein the constraint is a repetition constraint and wherein the operations of identifying the set of campaigns includes the operations of including campaigns that have run fewer times for the member than a specified member threshold.

19. The machine-readable medium of claim 15, wherein the constraint is an eligibility constraint and wherein the operations of identifying the set of campaigns includes the operations of identifying campaigns that have an eligible start slot after the specified slot.

20. The machine-readable medium of claim 15, further comprising, the operations of iterating the operations for a specified number of members.

21. The machine-readable medium of claim 20, wherein the specified number of members is a number of members in a predetermined group.
